(19) United States
(12) Patent Application Publication
(10) Pub. No.: US 2026/0355636 A1
(43) Pub. Date: Nov. 12, 2026

(54) USING GENERATIVE MACHINE LEARNING TO SUMMARIZE GAMING SESSIONS BASED ON LOG DATA

(71) Applicant: Microsoft Technology Licensing, LLC, Redmond, WA (US)

(72) Inventors: Francesco BONACCI, Madrid (ES); Diego COLOMBO, Farnham (GB)

(73) Assignee: Microsoft Technology Licensing, LLC, Redmond, WA (US)

(21) Appl. No.: 19/200,968

(22) Filed: May 7, 2025

(51) Int. Cl. A63F 13/67

(52) U.S. Cl. CPC A63F 13/67

(57) ABSTRACT

This document relates to summarization of computing experiences, such as video gaming sessions, by generating summaries with generative machine learning models. For instance, the disclosed implementations can store video game log data that includes logs generated by a game executable and/or a platform executable. The video game log data can be provided to one or more generative machine learning models with instructions to generate summaries of prior gaming sessions. The summaries can include narratives describing video frames from the prior sessions. In some cases, the video frames can be modified using a generative image model to enhance the summary.

### BACKGROUND

Modern video games can provide complex environments and sophisticated narratives to video game players. While this can provide rich video gaming experiences, it can be difficult for game players that step away from a game for some time to re-immerse themselves seamlessly back into the video gaming experience. For instance, a video game player might take a few days away from playing a video game due to work commitments, or even a few months away from playing the video game due to a major life event. When that player resumes playing the video game, they may find that they have forgotten where they left off during their previous gaming session.

One way to remind a video game player where they left off playing a given game is to display a static screenshot from a previous gaming session. While this can be a helpful reminder, a static screenshot does not convey a great deal of information to the video game player. Thus, a mere screenshot may not be sufficient to adequately remind the video game player how they arrived at the state where they last left off playing. For games with complex narratives or environments, this may degrade the player's experience the next time they play the game, as it may take some time for them to reorient themselves into the gaming experience.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for summarizing video gaming sessions. One example includes a computer-implemented method comprising accessing a database storing video game log data relating to a previous video gaming session involving a video game player playing a video game. The method can also include selecting a subset of video game log data from the database for summarization by a generative machine learning model. The method can also include inputting the selected subset of video game log data to the generative machine learning model. The method can also include instructing the generative machine learning model to synthesize a summary of the previous video gaming session based at least on the selected subset of video game log data. The method can also include receiving the synthesized summary of the previous video gaming session from the generative machine learning model. The method can also include outputting the synthesized summary of the previous video gaming session to the video game player.

Another example entails a system that includes a processor and a storage medium storing instructions. When executed by the processor, the storage medium storing instructions can cause the system to access a database storing video game log data relating to a previous video gaming session involving a particular video game player playing a particular video game. The storage medium storing instructions can also cause the system to select a subset of video game log data from the database for summarization by a generative machine learning model. The storage medium storing instructions can also cause the system to input the selected subset of video game log data to the generative machine learning model. The storage medium storing instructions can also cause the system to instruct the generative machine learning model to synthesize a summary of the previous video gaming session based at least on the selected subset of video game log data. The storage medium storing instructions can also cause the system to receive the synthesized summary of the previous video gaming session from the generative machine learning model. The storage medium storing instructions can also cause the system to output the synthesized summary of the previous video gaming session to the particular video game player.

Another example includes a computer-readable storage medium storing computer-readable instructions which, when executed by a processing unit, cause the processing unit to perform acts. The acts can include accessing a database storing video game log data relating to a previous video gaming session involving a video game player playing a video game. The acts can also include selecting a subset of video game log data from the database for summarization by a generative machine learning model. The acts can also include inputting the selected subset of video game log data to the generative machine learning model. The acts can also include instructing the generative machine learning model to synthesize a summary of the previous video gaming session based at least on the selected subset of video game log data. The acts can also include receiving the synthesized summary of the previous video gaming session from the generative machine learning model. The acts can also include outputting the synthesized summary of the previous video gaming session to the video game player.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1A illustrates an example workflow for generating and providing summaries of video gaming sessions, consistent with some implementations of the present concepts.

FIG. 1B illustrates an example knowledge graph that can be employed for generating summaries, consistent with some implementations of the present concepts.

FIGS. 2A-2D, 3A-3F, 4A-4E, and 5A-5C illustrate example user experiences, consistent with some implementations of the present concepts.

FIG. 6 illustrates an example of a system in which the disclosed implementations can be performed, consistent with some implementations of the disclosed techniques.

FIG. 7 illustrates an example of a method for providing video game summaries, consistent with some implementations of the present concepts.

FIG. 8 illustrates an example generative language model, consistent with some implementations of the present concepts.

FIG. 9 illustrates an example generative image model, consistent with some implementations of the present concepts.

FIG. 10 illustrates an example computer vision model, consistent with some implementations of the present concepts.

FIG. 11 illustrates an example vision language model, consistent with some implementations of the present concepts.

### DETAILED DESCRIPTION

### Overview

As noted above, modern video games can provide rich video gaming experiences involving complex environments, sophisticated narratives, a wide range of characters, different levels and objectives, etc. When a video game player steps away from playing a complex video game for a period of time, it may be difficult for that player to immediately pick up where they left off. For instance, the user may not recall how they got to a particular location, what equipment their character currently has, what bosses they have already beaten, what level they are currently on, etc.

A static screen shot from the most recent video gaming session could offer a player some clues as to where they left off playing a video game. For a relatively simple video game, this might be adequate. However, a single screenshot may omit important details that could be useful to help re-immerse the user into the video gaming experience. This is particularly true when the prior video gaming session involved a complex sequence of events that are pertinent to the current video gaming session.

The disclosed implementations offer techniques for generating informative narrative summaries based on historical gaming context to reintegrate a video game player into a video game experience. For instance, various sources of data such as log files generated by a video game and/or a video gaming platform can be stored during gameplay. These log files can be used to generate summaries of video gaming sessions using generative machine learning models. Then, when a player returns to play a video game for a subsequent video gaming session, that player can be provided with a generated summary of one or more previous video gaming sessions. Because the generated summaries provide a rich source of information describing the previous video gaming session, the player can quickly reorient themselves back into the video gaming experience.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “video game log data,” as used herein, refers to various types of data associated with gameplay of a video game. Video game log data can include “platform log data” generated or collected by a video gaming platform, such as an online game playing service utilized by multiple video games or an operating system that runs on a gaming console. For instance, platform log data can include sequences of inputs to a video game (e.g., user controls) and/or outputs of the video game (e.g., audio, video, or haptic output) during gaming sessions, achievements, saves, restarts, etc. Video game log data can also include “game executable log data,” which is game data that can be generated and/or stored by the video game itself during execution. Generally, game executable log data can include internal state information pertaining to aspects of video game play that are not directly accessible by a video gaming platform.

The term “summary,” as used herein, broadly refers to any type of output that conveys information about a video gaming session. For instance, a summary can include one or more natural language narratives describing a video gaming session. A summary can also include one or more images (e.g., video frames) relating to a video gaming session, where the video frames can be the same video frames presented during that session or modified, e.g., by a generative image model. The term “event” broadly refers to any occurrence during video game play, e.g., an interaction with a video game character, encountering an enemy, obtaining an item in inventory, completing a level, etc.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, videos, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a Kolmogorov-Arnold network, a state space model, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Workflow

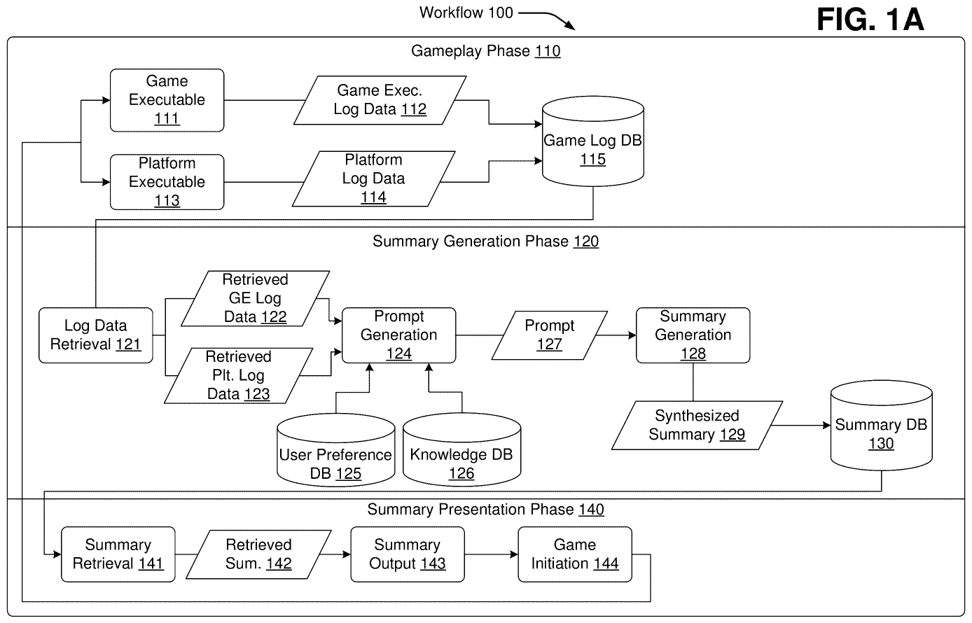

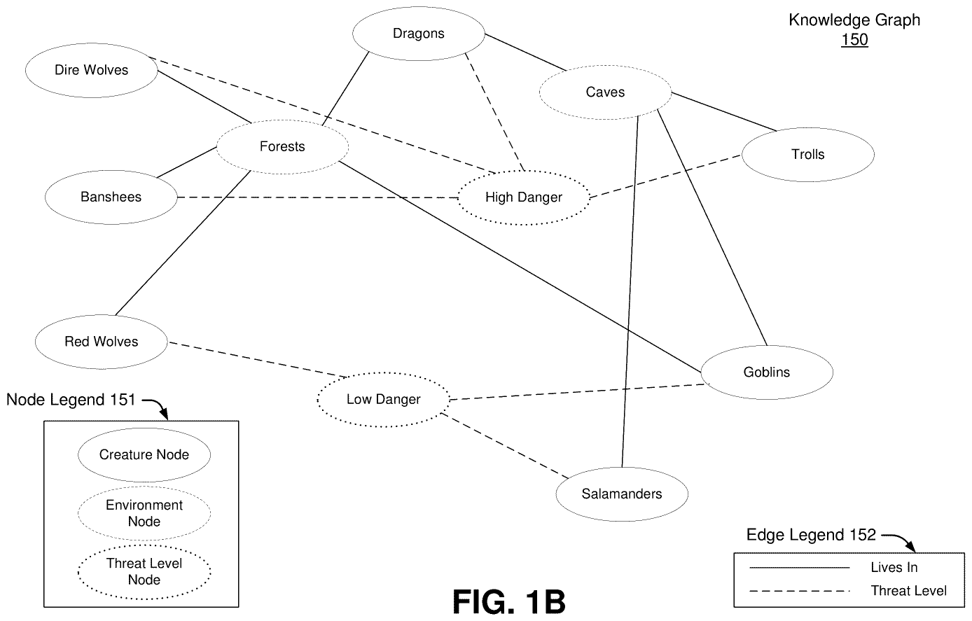

FIG. 1A illustrates a workflow 100 for generating and presenting summaries of video gaming sessions. Workflow 100 includes three overall phases—a gameplay phase 110, a summary generation phase 120, and a summary presentation phase 140. Each of these phases is discussed in more detail below.

During gameplay phase 110, a game executable 111 generates and/or stores game executable log data 112 and a platform executable 113 generates and/or stores platform log data 114. For instance, the game executable can be a computer program that implements a particular game, such as an adventure game, a racing game, a sports game, etc. The platform executable can be a computer program that provides various types of functionality used by multiple different game executables, such as an operating system, streaming services, user accounts, and development tools such as standard development kits.

The game executable log data 112 and the platform log data 114 are used to populate a game log database 115. For instance, the game executable log data can include internal state information that the game executable 111 can log during execution. Game executable log data could include in-game events that identify a new level achieved by a user, a boss encountered by the user, a weapon or other inventory item obtained by the user, etc. The platform log data could include inputs to the game executable or outputs by the game executable that are accessible to the platform executable without necessarily accessing internal game state. For instance, the platform executable may be able to access controller inputs to the game executable or video, audio, and/or haptic output by the game executable without the game executable necessarily logging this information.

Once the game log database 115 has been populated with game executable log data 112 and/or platform log data 114 for at least one video gaming session, workflow 100 can proceed to summary generation phase 120. During the summary generation phase, log data retrieval 121 can retrieve data from the game log database 115, including retrieved game executable log data 122 and retrieved platform log data 123. The retrieved game executable log data and retrieved platform log data can be employed for prompt generation 124, which can also involve accessing user preference database 125 and knowledge database 126. Generally speaking, the user preference database can store user preferences that can be used as context for generating summaries and the knowledge database can store game knowledge that can be used as context for generating summaries. The prompt 127 can include retrieved game executable log data, retrieved platform log data, user preferences, and/or knowledge data as context. The prompt can be employed for summary generation 128, which can involve requesting one or more generative models to generate a summary of one or more previous gaming sessions. The synthesized summary 129 can be output to summary database 130. The synthesized summary can include one or more synthesized narratives describing a previous game session, one or more video frames from the previous gaming session, and/or one or more synthesized images obtained by modifying a video frame from the previous gaming session.

Once the summary database 130 has been populated with at least one generated summary, workflow 100 can proceed to summary presentation phase 140. During the summary presentation phase, summary retrieval 141 can obtain a retrieved summary 142 from summary database 130, and summary output 143 can present the summary to a user. For instance, as described more below, summary retrieval and presentation can be performed in response to a user request to execute a particular video game. As shown more below, the summary can be presented by presenting one or more video frames or synthesized images (or video) to the video game player while concurrently outputting synthesized narratives via displayed text and/or audio narration.

Game initiation 144 can initiate the game after presentation of the summary, and workflow 100 can then return to gameplay phase 110 where additional game and platform data is generated for use in subsequent summaries. Note that, in some implementations, game initiation can be performed concurrently with summary retrieval and output, e.g., the game can be initiated and a summary retrieved and presented while the game is loading.

### Example Knowledge Data

As noted above, knowledge database 126 can store knowledge relating to one or more video games. Generally speaking, knowledge about a given video game can be useful context for a generative model to generate a summary of the game. For instance, knowledge data could simply be a textual description of a given video game obtained from a game developer's website, user reviews or other sources of community knowledge, etc.

In some implementations, knowledge data can be provided in a structured format that conveys relationships between various game entities. For instance, FIG. 1B shows an example knowledge graph 150. As shown in node legend 151, knowledge graph 150 includes 3 types of nodes—creature nodes, environment nodes, and threat level nodes. As shown in edge legend 152, knowledge graph includes two types of edges—lives in edges and threat level edges. Relationships between entities can be discovered by traversing the graph.

Thus, for example, knowledge graph 150 can be used to infer that trolls live in caves and are a high danger creature. On the other hand, red wolves live in forests and are a low danger creature. Dragons can live in both forests and caves and are a high danger creature. In some implementations, knowledge can be extracted from a knowledge graph to assist in prompt generation. For instance, a vision-language model could be prompted to detect whether a forest or a cave has appeared in one or more video frames output by a game. Then, a subsequent prompt could list the plausible creatures that could be present at that location with a description of their threat level, while omitting creatures that do not live in that type of location. In this manner, the vision-language model can be grounded with game-specific knowledge that can assist the model with generating a summary of one or more video game frames.

Note that knowledge graphs or other data structures can include various other types of information. For instance, nodes could represent locations, levels, weapons, potions, etc., with connections to other nodes indicating creatures present at certain locations, vulnerable to certain weapons, etc. In a racing game, nodes could represent different racetracks, different vehicles, different vehicle parts (tires, engines, etc.), as well as nodes representing characteristics of each of these entities.

Thus, knowledge graphs or other data structures can be employed for retrieval-augmented generation of video game summaries. By retrieving a subset of relevant knowledge data from a knowledge database and using that subset as context for a summary generation prompt, a generative model can be grounded to generate summaries that are pertinent to the video game log data being summarized. This can assist in summary generation by omitting irrelevant knowledge data that could cause hallucinations or otherwise inaccurate generation of summaries by the generative model.

### Example User Experiences

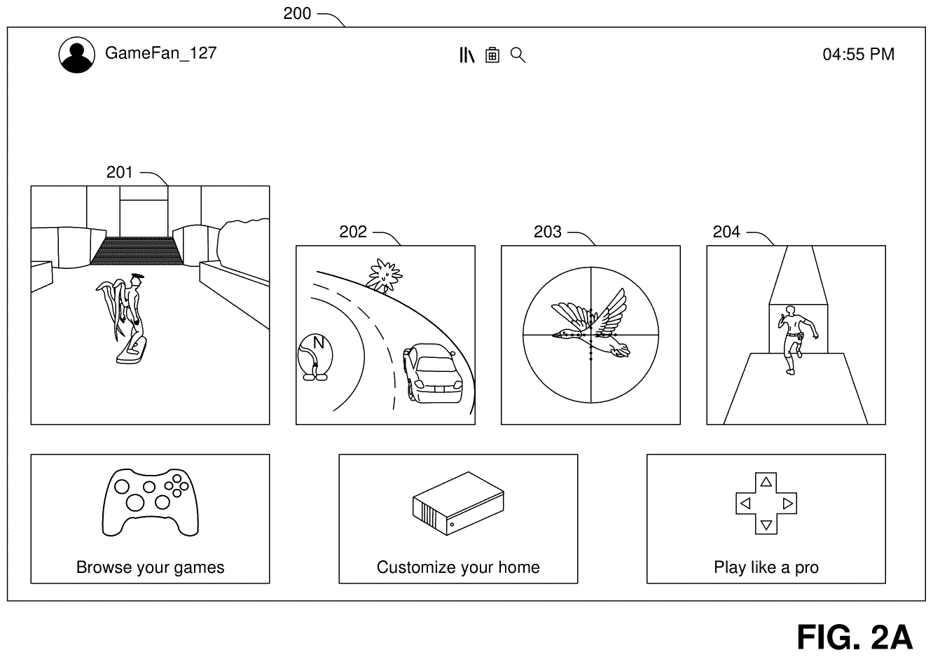

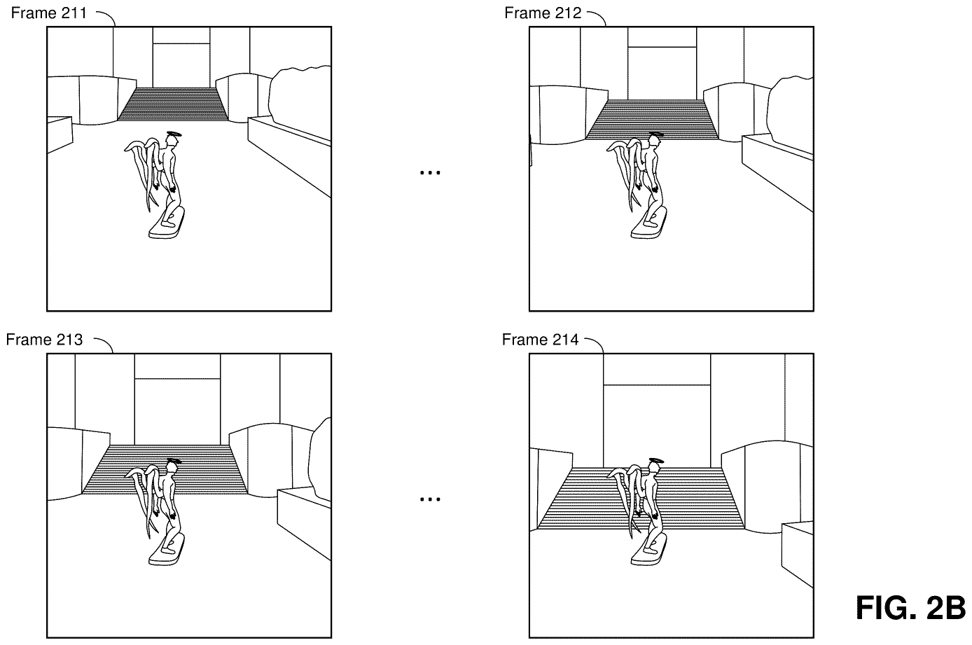

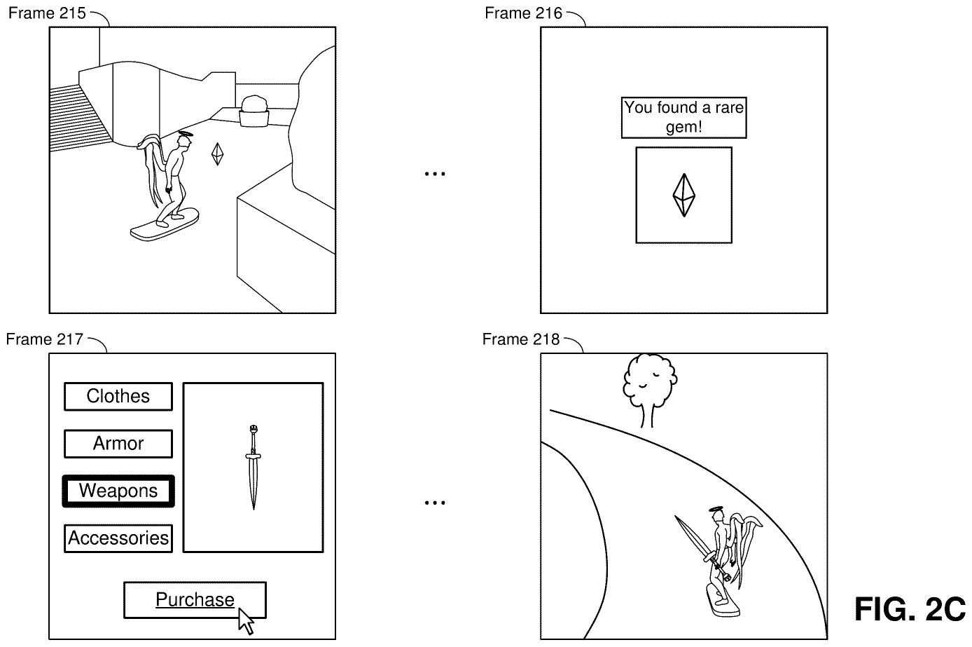

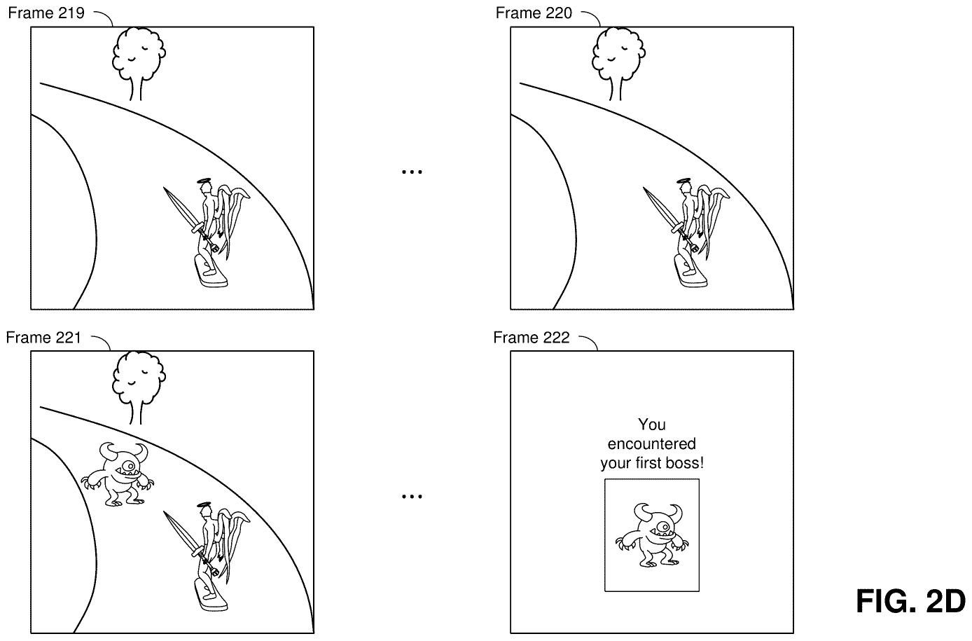

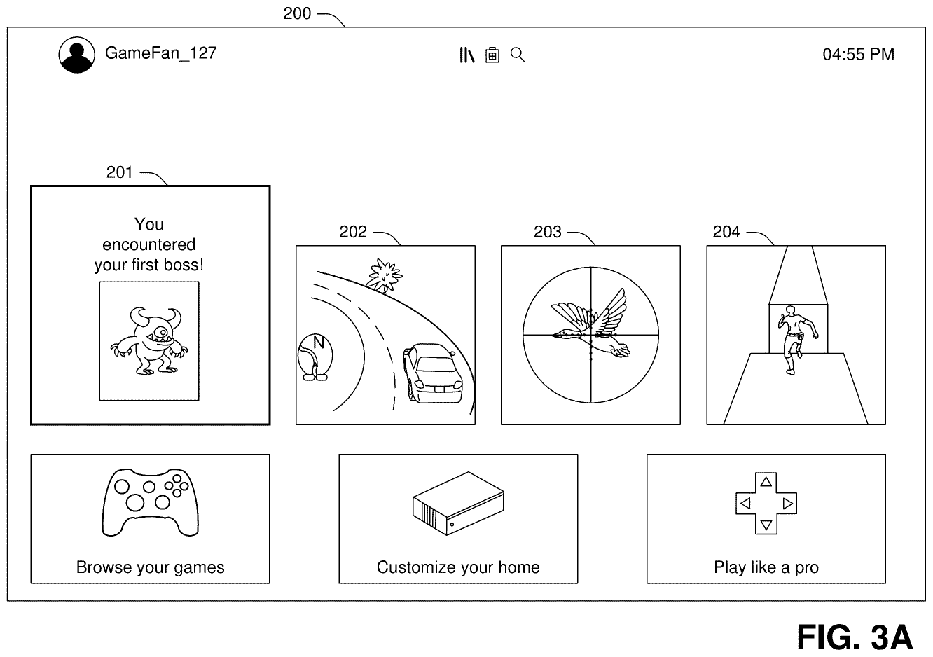

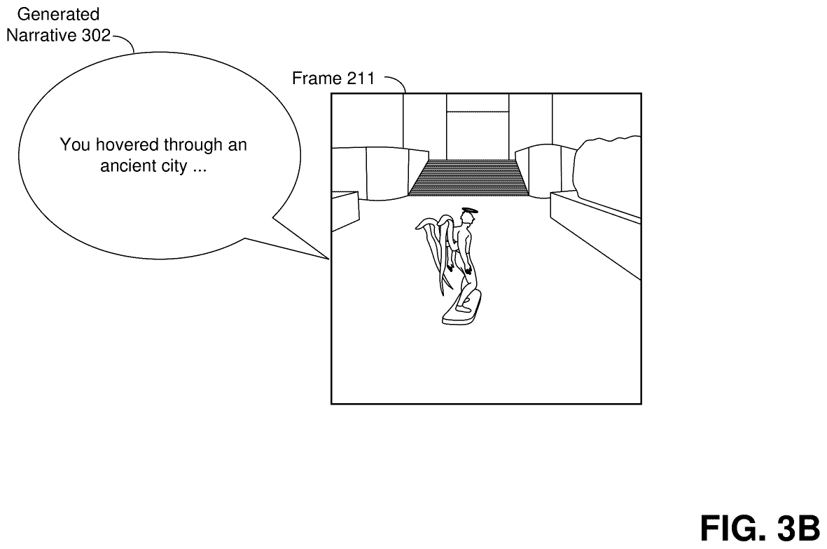

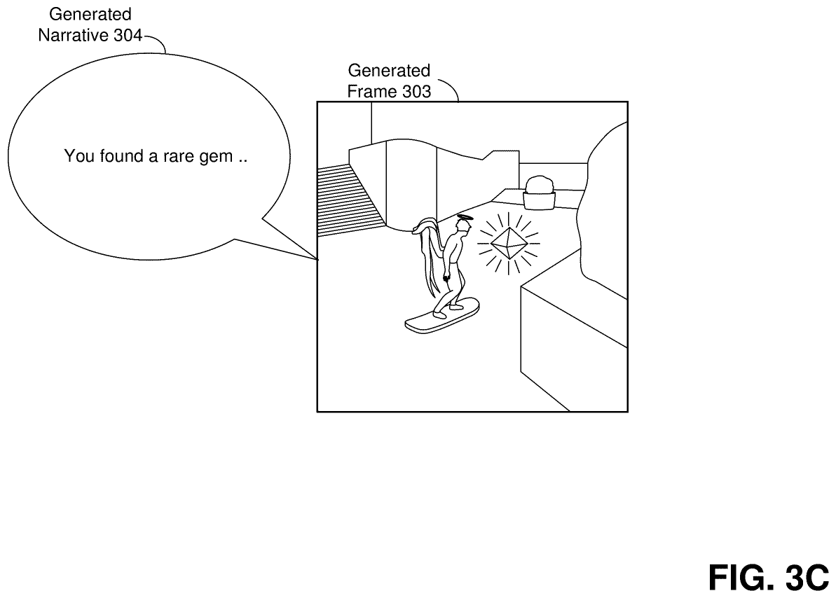

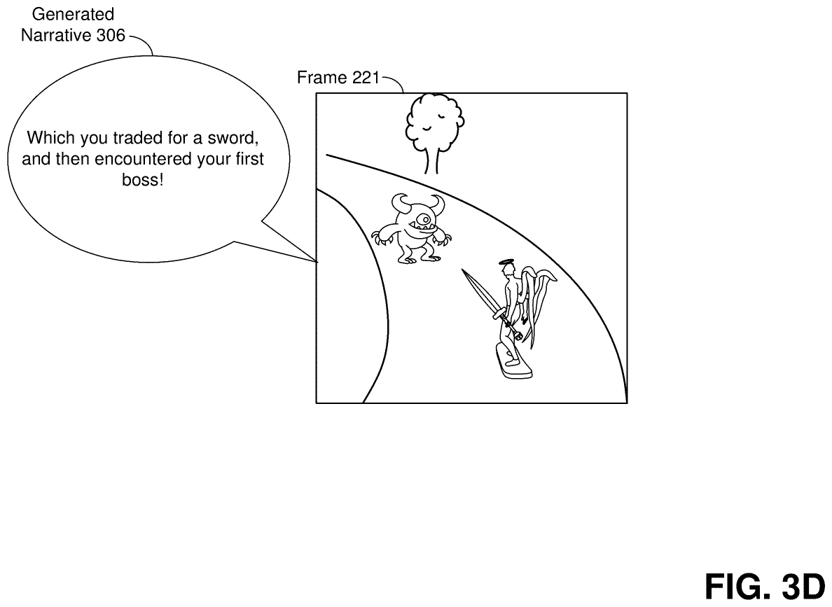

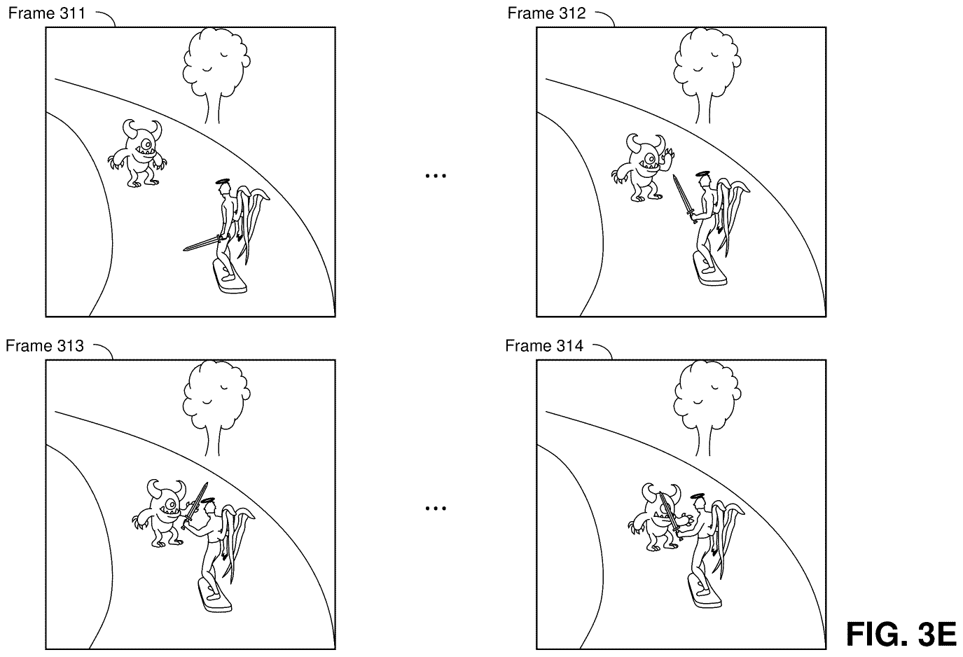

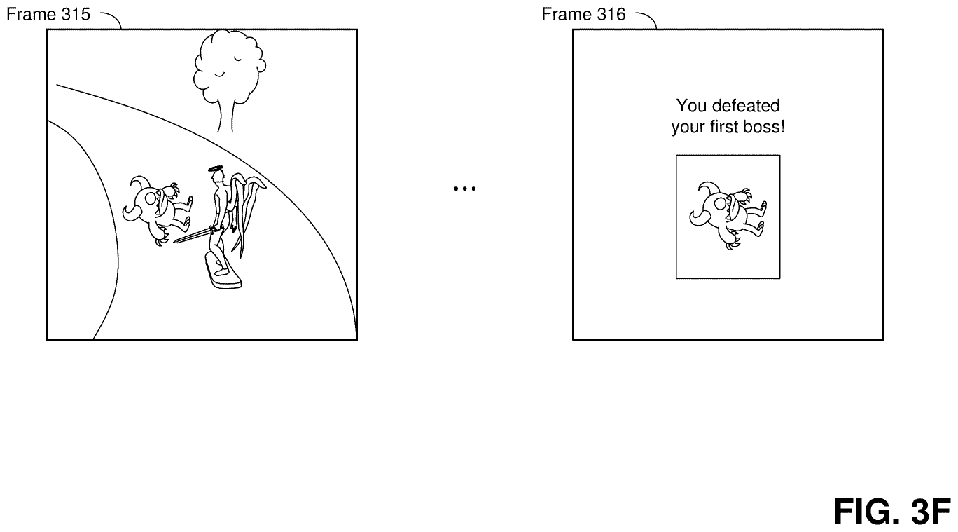

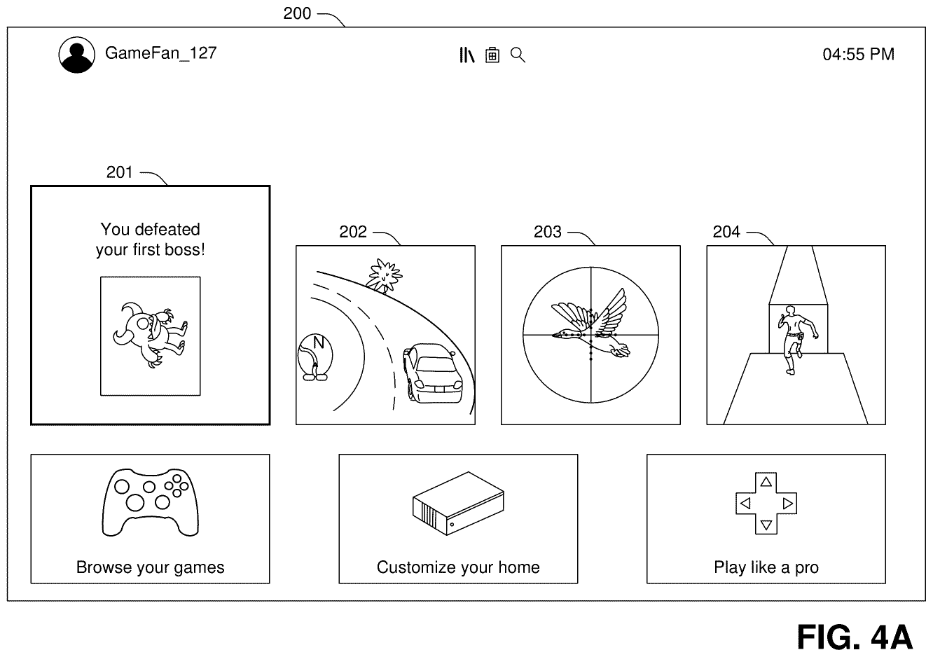

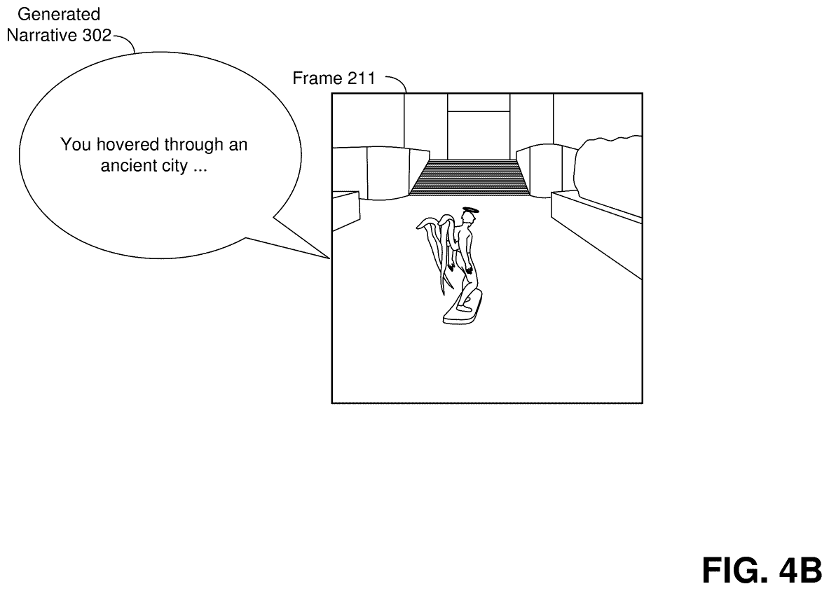

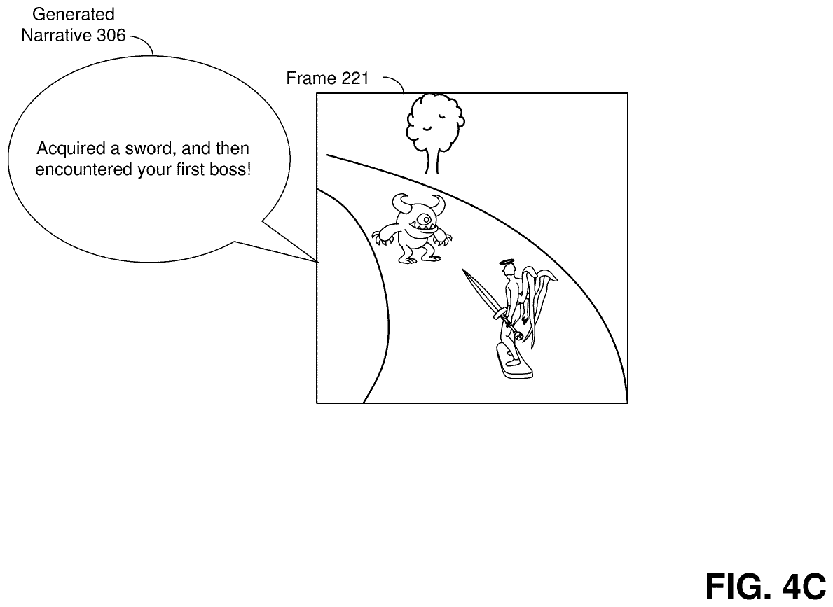

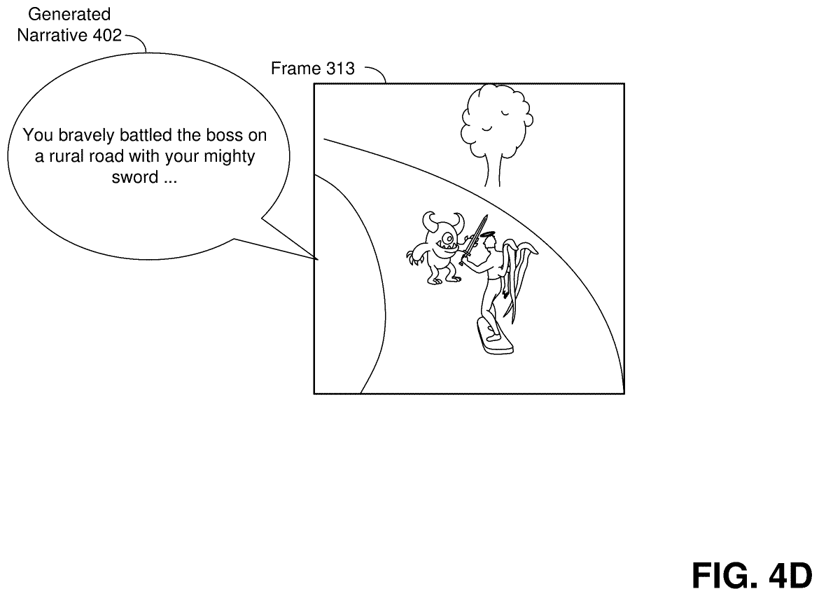

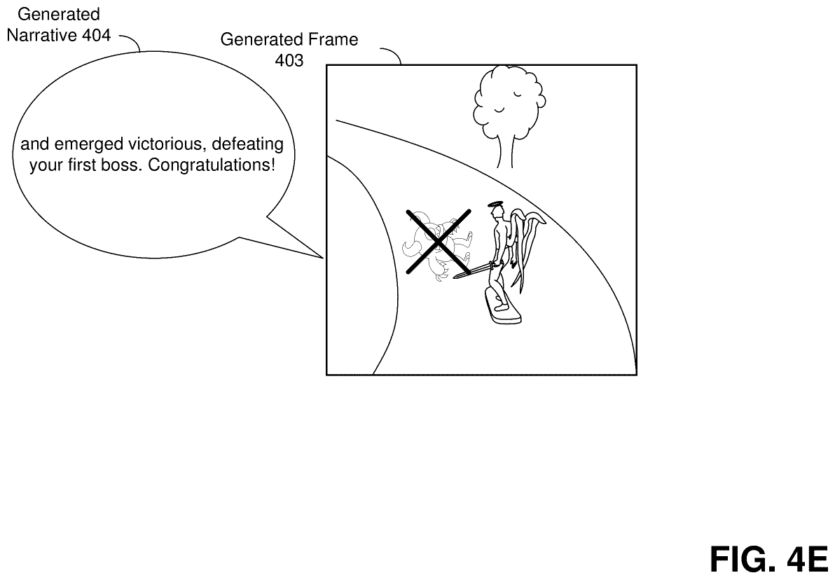

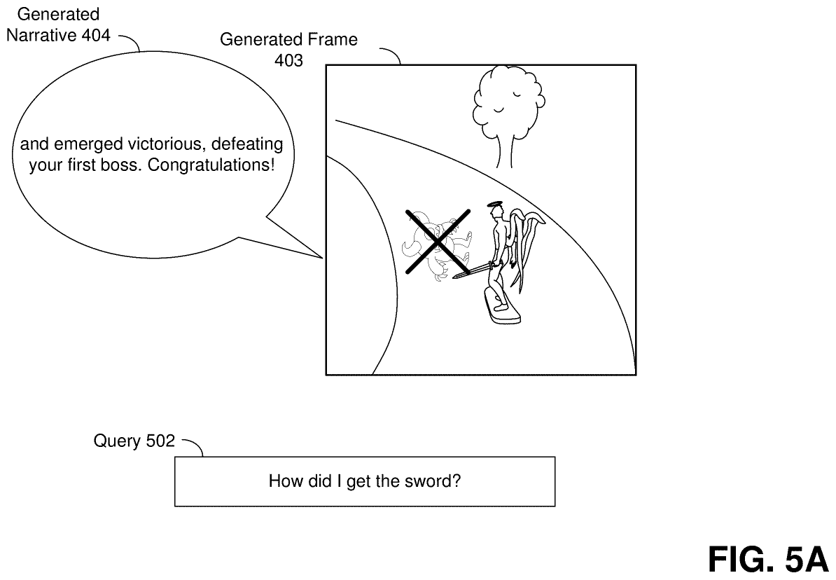

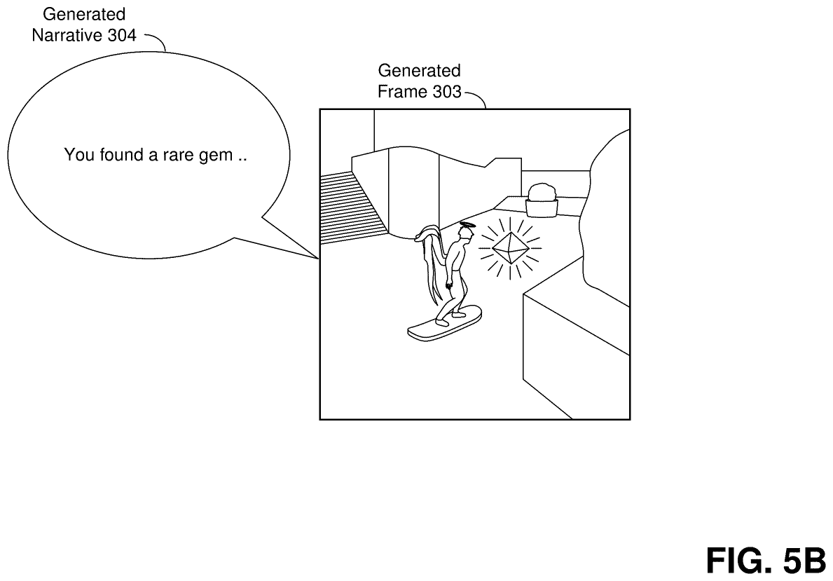

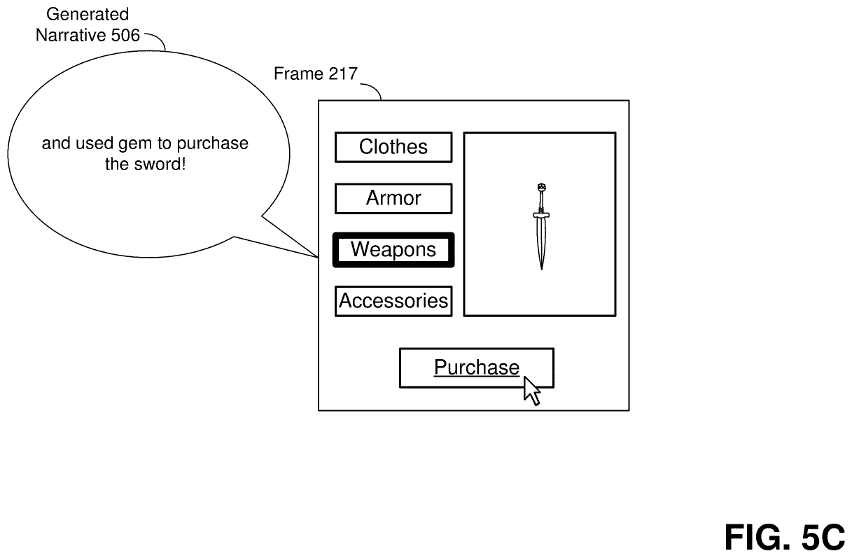

The following generally describes some user experiences relating to playing a fantasy video game. First, a video game player plays the fantasy video game during a first gaming session, as shown below in FIGS. 2A-2D. Then, the player stops playing the game for a period of time and returns to play a second session. When the player returns for a second session, a summary of the first session is presented and then the player plays the second session, as shown below in FIGS. 3A-3F. The player stops play again and, when they return again to play a third session, a summary of both the first and second sessions is presented to the player, as shown below in FIGS. 4A-4E. The player can also query for specific information about previous sessions and receive an answer to their query, as shown below in FIGS. 5A-5C.

### First Example User Experience

FIG. 2A illustrates an example home screen 200. When a video game player named “GameFan_127” turns on their device, activates a gaming application, and/or stops playing a given video game, home screen 200 can be displayed. The home screen includes various user interface elements, including a thumbnail 201 for a fantasy game where a character rides a hoverboard, a thumbnail 202 for a racing game, a thumbnail 203 for a hunting game, and a thumbnail 204 for a sports game. The player can navigate the thumbnails via a directional button on a video game controller, a mouse, a keyboard, etc. The currently-selected thumbnail is expanded to convey to the user which thumbnail is currently selected, in this case thumbnail 201. The player can then click a button on the video game controller, keyboard, mouse, etc. to initiate a new session of the fantasy game.

FIGS. 2B, 2C and 2D collectively show video frames output by the fantasy game during gameplay during this first gaming session. FIG. 2B shows frame 211, frame 212, frame 213, and frame 214. FIG. 2C shows frame 215, frame 216, frame 217, and frame 218. FIG. 2D shows frame 219, frame 220, frame 221, and frame 222. Note that these FIGS. use ellipses to convey that not every frame can be shown, but rather the FIGS. illustrate a subset of frames output by the video game during the first gaming session.

In FIG. 2A, a winged character is shown navigating through an ancient city while riding a hoverboard. In FIG. 2C, the character discovers a rare gem, as indicated by frame 216, and uses the gem to purchase a sword, as shown in frame 217. The character then proceeds onto a rural road, as shown in frame 218. In FIG. 2D, the winged character proceeds down the road until encountering a boss, e.g., an enemy (e.g., a goblin) that the winged character can attempt to defeat with the sword. For the purposes of this example, assume that the video game player decides to stop gameplay at this time.

### Second Example User Experience

Assume that the video game player eventually decides to return and play the fantasy video game again at a later time. FIG. 3A illustrates example home screen 200 the next time GameFan_127 turns on their device and/or returns to the homepage. Note that thumbnail 201 updated to reflect the result of the previous gaming session involving the fantasy game.

At this time, the fantasy game can begin loading, e.g., retrieving game state data from storage and loading the game state into memory. Concurrently, the player can be presented with a summary of the first video gaming session. The summary can include video frames from the previous gaming session, images (e.g., modified frames) generated by a generative image model and/or narratives generated by a generative language model, as described more below.

For example, FIG. 3B shows frame 211 and a generated narrative 302, FIG. 3C shows a generated frame 303 and a generated narrative 304, and FIG. 3D shows frame 221 and a generated narrative 306. Here, frame 211 and frame 221 are the same frames that were output during the previous gaming session. However, generated frame 303 is a modified version of frame 216 (FIG. 2C) that has been modified by a generative image model to emphasize the gem, e.g., by slightly increasing the size of the gem relative to the original frame and highlighting the gem.

Generated frames can be obtained during workflow 100 by retrieving video game frames output by the game. For instance, frames can be collected by the platform executable at a specified rate. Some or all of retrieved frames can be input to a generative image model with a prompt requesting that the generative image model generate images that modify the retrieved images to match corresponding narratives generated by the generative language model.

After presentation of one or more frames and narratives, the fantasy video game can be executed, and the video game player can play the game for a second video gaming session. FIGS. 3E and 3F collectively show video frame output by the fantasy game during gameplay during a second gaming session. FIG. 3E shows frame 311, frame 312, frame 313, and frame 314. FIG. 3F shows frame 315 and frame 316, again using ellipses to convey that not all frames output by the fantasy game are shown.

In FIG. 3E, the winged character battles the boss with the sword that they obtained in the first gaming session. In FIG. 3F, the winged character defeats the boss in frame 315, and the player is notified that they have defeated their first boss in frame 316. For the purposes of this example, assume that the video game player decides to stop gameplay at this time.

### Third Example User Experience

Assume that the video game player eventually decides to return and play the fantasy video game again at a later time. FIG. 4A illustrates example home screen 200 the next time GameFan_127 turns on their device and/or returns to the homepage. Note that thumbnail 201 updated to reflect the result of the previous gaming session involving the fantasy game.

At this time, the fantasy game can begin loading, e.g., retrieving game state data from storage and loading the game state into memory. Concurrently, the player can be presented with a summary of both the first video gaming session and the second video gaming session.

For example, FIG. 4B shows frame 211 and a generated narrative 302, FIG. 4C shows frame 221 and a generated narrative 306, FIG. 4D shows frame 313 and generated narrative 402, and FIG. 4E shows a generated frame 403 and a generated narrative 404. Here, the video game player is presented with frames and narratives from the first video gaming session that they have previously seen-frame 211, generated narrative 302, frame 221, and generated narrative 306. The video game player is also presented with newly-seen frames and narratives relating to the second video gaming session-frame 313, generated narrative 402, generated frame 403, and generated narrative 404. Note that generated frame 403 has been produced by a generative image model that modifies frame 315 (FIG. 3F) to emphasize that the boss has been defeated.

### Fourth Example User Experience

In some cases, the summary presented to a video game player may omit information that the player wishes to know. For the following example, the video game player may decide while viewing the summary described above that they want to know more about what happened during a previous session. The player may enter a specific sequence of video game controller inputs or a keyboard shortcut to invoke a query box 502, as shown in FIG. 5A. Then, the player can enter the query “How did I get the sword?”

At this time, the game log database 115 can be accessed to search for video frames using a computer vision or vision-language model to find the first frame where the sword appears. Then, that frame and subsequent frames (e.g., the next 30 seconds) can be analyzed with the vision-language model to determine when the user acquired the sword in inventory. In addition, previously-generated summaries can be searched to determine related information, e.g., generated narrative 304 and generated narrative 306 indicate that the sword was purchased with a gem.

After gathering the frame where the sword first appears, one or more subsequent frames where the sword was acquired in inventory, and the previously-generated summaries, the user can be presented with an answer to their query pertaining to the sword. FIG. 5B shows generated frame 303 and generated narrative 304, and FIG. 5C shows frame 217 and generated narrative 506. Here, generated frame 303 and generated narrative 304 are previously-generated summaries that help answer the user's question. However, since the previous summaries do not completely answer the user's question, frame 217 and generated narrative 506 can be output responsive to the query to provide additional information pertaining to the query. Said another way, the previously-presented summary can be augmented with a newly-generated narrative and corresponding frame to answer the user's question pertaining to a previous gaming session.

### Example System

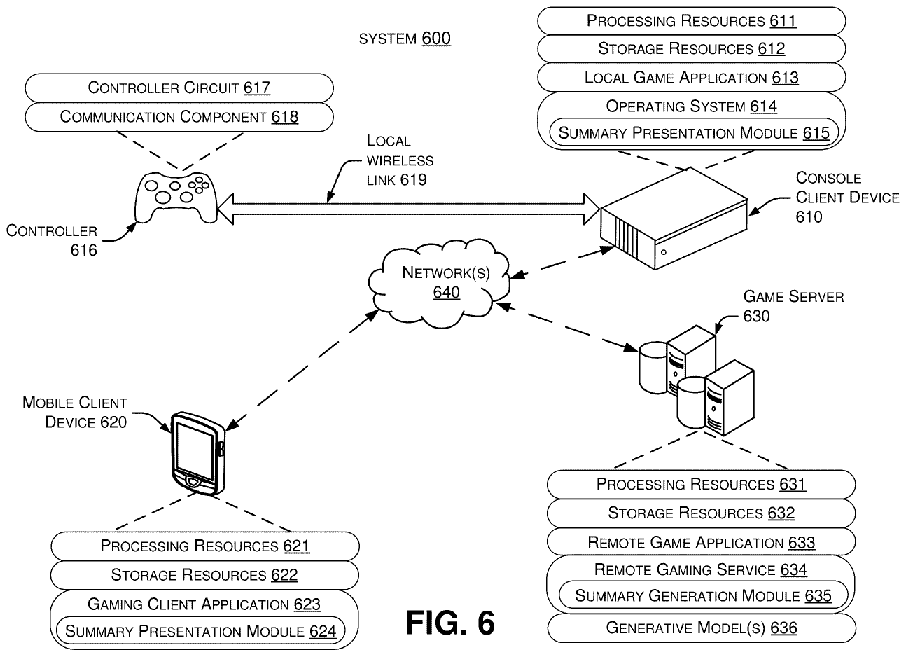

The present concepts can be implemented in various technical environments and on various devices. FIG. 6 shows an example system 600 in which the present concepts can be employed, as discussed more below. As shown in FIG. 6, system 600 includes a console client device 610, a mobile client device 620, and a game server 630. Console client device 610, mobile client device 620, and game server 630 are connected over one or more networks 640.

Console client device 610 can have processing resources 611 and storage resources 612, mobile client device 620 can have processing resources 621 and storage resources 622, and game server 630 can have processing resources 631 and storage resources 632. The devices of system 600 may also have various modules that function using the processing and storage resources to perform the techniques discussed herein, as discussed more below.

Console client device 610 can include a local game application 613 and an operating system 614. The local game application can execute using functionality provided by the operating system. The operating system can include a summary presentation module 615. The local game application can generate game executable log data, and the operating system can generate platform log data. The game executable log data and the platform log data can be transmitted to game server 630 as discussed more below.

The operating system can obtain control inputs from controller 616, which can include a controller circuit 617 and a communication component 618. The controller circuit can digitize inputs received by various controller mechanisms such as buttons or analog input mechanisms such as joysticks. The communication component can communicate the digitized inputs to the console client device over the local wireless link 619. The control interface module on the console can obtain the digitized inputs and provide them to the local application.

Mobile client device 620 can have a gaming client application 623. The gaming client application can send inputs from a touchscreen on the mobile client device and/or peripheral game controller to the game server 630, and can also receive game outputs, such as video, chat, and/or audio streams, from the server(s) and output them via a display, loudspeaker, headset, etc. The gaming client application can include a summary presentation module 624.

Game server 630 can include a remote game application 633, which can correspond to a streaming version of a video game. The game server 630 can also have a remote gaming service 634, which can execute the remote game application and provide various support services, such as maintaining user accounts, tracking achievements, etc. The remote gaming service can also include a summary generation module 635 and one or more generative machine learning models 636. The remote gaming application 633 can generate game executable log data and the remote gaming service 634 can generate platform log data, as discussed more below.

The summary generation module 635 on game server 630 can use generative model(s) 636 to generate summaries as described elsewhere herein. The summaries can be output via console client device 610 and/or mobile client device 620 when a player initiates a new video gaming session.

Note also that other implementations are possible. For instance, console client device and/or mobile client device could generate summaries locally, using remote and/or local generative machine learning models. In addition, mobile client device 620 could execute a local instance of a gaming executable, and/or console client device could be employed for streaming gaming services provided by game server 630. In other cases, the game server 630 may access one or more generative models hosted on other servers.

### Example Method

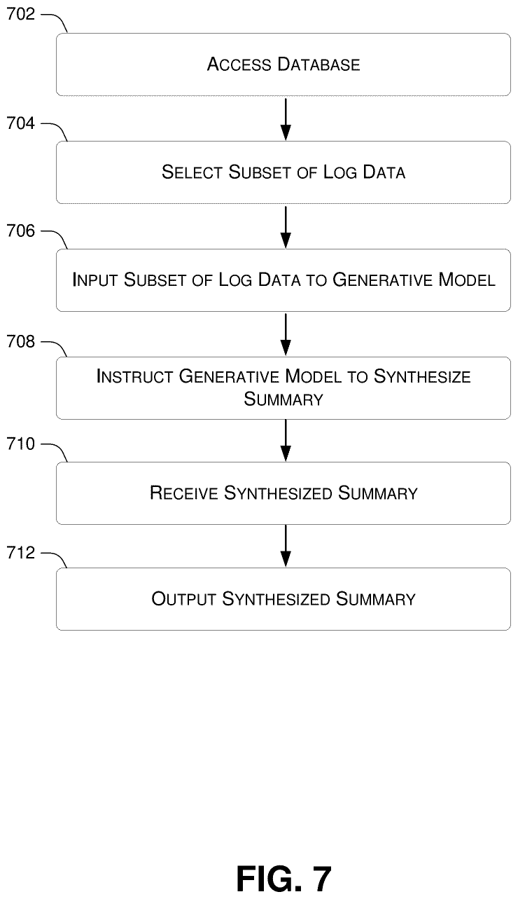

FIG. 7 illustrates an example computer-implemented method 700, consistent with some implementations of the present concepts. Method 700 can be implemented on many different types of devices, e.g., by one or more cloud servers, by a client device such as a laptop, tablet, or smartphone, or by combinations of one or more servers, client devices, etc.

Method 700 begins at block 702, where a database storing video game log data is accessed. For instance, the database can store game executable log data that was logged by a game executable during one or more previous gaming sessions where a video game player played a video game. The database can also store platform log data that was logged by a video gaming platform executable, such as an operating system or streaming video game service, during the one or more previous gaming sessions.

Method 700 continues at block 704, where a subset of the video game log data is selected. For instance, game executable log data can identify important events that occurred during the one or more previous gaming sessions, a computer vision model could detect significant events in video frames in the platform executable log data, etc. Salient events in the game executable log data and/or salient video frames can be included in the selected subset of video game log data for subsequent summary generation.

Method 700 continues at block 706, where the subset of log data is input to a generative machine learning model. For instance, selected events logged by the game executable can have associated descriptions that are input to a generative machine learning model, selected video frames can be input to the generative machine learning model, etc. In some implementations, user preferences and/or knowledge data pertaining to entities in the video game can also be employed for summary generation, e.g., by inputting user preferences and/or knowledge data to the generative machine learning model with a prompt instruction the model to generate the summary using the preferences and/or knowledge data as context.

Method 700 continues at block 708, where the generative machine learning model is instructed to synthesize a summary of at least one of the previous video gaming sessions based on the subset of video game log data. For instance, the generative machine learning model can synthesize a narrative describing a sequence of events and/or video frames from the subset of log data. The generative machine learning model can also modify selected video frames as described elsewhere herein. In some cases, the generative machine learning model is a single multi-modal model that performs both narrative generation and image modification. In other cases, a generative language model is employed for narrative generation and a separate generative image model is employed to modify video frames.

Method 700 continues at block 710, where the synthesized summary is received from the generative machine learning model. For instance, the synthesized summary can include a sequence of original or synthesized video frames with corresponding synthesized narratives. Each synthesized narrative can be associated with a corresponding video frame.

Method 700 continues at block 712, where the synthesized summary is output to the video game player. For instance, the sequence of original or synthesized video frames can be displayed to the video game player while the associated narratives are displayed as text and/or narrated via audio.

### Additional Implementations

The examples introduced above provide an overview of the disclosed concepts. The following section describes additional details on the concepts described above.

In some implementations, game executable log data can serve as a basis for generating summaries, without necessarily employing platform log data. For instance, a game executable could generate storage logs with entries describing levels achieved during gameplay, locations visited, enemies defeated, items acquired in inventory, narrative changes, etc. These storage logs could be formatted in a manner (e.g., using JavaScript Object Notation or “JSON”) that allows the summary generation module to parse the logs to extract natural language terms describing the entries. Then, specific entries could be selected, e.g., based on other information in the logs indicating the relative significance of the entries. For example, each entry could have an associated attribute identifying a significance level, and only entries having a significance level above a threshold could be extracted. Then, associated natural language descriptions of those entries could be input to a generative machine learning model to generate narratives describing those entries. Each entry could have timestamps that can be used to identify the video frames that were displayed when each entry was logged, and those video frames could be played back with the narratives. In other cases, a generative image model could be employed to synthesize one or more entirely-new frames and/or modify the associated video frames before they are output to the user.

In other implementations, platform log data can serve as a basis for generating summaries, without necessarily employing game executable log data. For instance, video frames logged by the platform executable can be processed using a computer vision model to detect significant events. Then, video frames depicting significant events could be processed with a generative machine learning model to synthesize narratives describing those video frames. For instance, in some cases, a multi-modal, vision-capable model could be prompted to perform an analysis of video to identify frames with significant events. The video frames could be output with the synthesized narratives as they were originally output by the video game, or as modified by a generative image model.

In still further implementations, game executable log data can serve as a basis for choosing which platform log data is employed for summary generation. As noted above, each entry in the game executable log data can have a timestamp and a corresponding significance level. The timestamps for significant events can be correlated to video frames output at the time those events occurred. The events in the game executable log data and/or the video frames associated with those events could be employed for summary generation as described previously.

In some cases, platform log data can be generated in a comprehensive fashion, e.g., each video frame, game input, haptic and/or audio output frame, etc., can be stored during a given gaming session. In other implementations, platform log data can be logged selectively. For instance, one approach involves using constant sampling rates of video and/or audio frames, e.g., every five seconds, every 30 seconds, every I-frame, etc. In other implementations, the game executable can invoke an application programming interface that informs the platform executable when a significant event takes place, and the platform executable can create platform event log entries (e.g., a snapshot of a current video frame) at that time. In still further implementations, the platform executable can monitor video output to detect significant changes in the video (e.g., computing a difference image) and capture one or more output frames whenever this occurs. In still further implementations, the platform executable can employ a vision-capable multi-modal generative model to monitor video output to detect significant events and then log those frames. As another example, some implementations may cease creating platform log entries when user inactivity is detected, e.g., no user input for a threshold period of time.

With respect to using computer vision to detect significant events, this can be implemented in several different ways. For example, a computer vision model with or without generative capabilities can be employed to detect specific in-game events that are designated as being significant explosions, battles, changes in location or level, user interface elements (e.g. inventory GUIs), on-screen text, scores, etc. As another example, a vision-enabled generative language model could be prompted to evaluate video frames to determine whether the frames depict significant events, potentially with some in-context examples describing significant events such as those mentioned previously. In some cases, in-context negative examples can also be provided, e.g., examples of relatively insignificant events such as traveling along a relatively unchanging course of a racetrack, observing other characters in a game without interaction, etc.

As another point, recall from the previous examples that a summary can describe multiple previous gaming sessions. In some implementations, more detail can be provided on relatively more recent sessions. For instance, if a user plays a first gaming session, the user can be provided with five images and corresponding narratives when they return for a second session. When the user returns for a third session, they can be provided with three images and corresponding narratives describing the first session and five images and corresponding narratives describing the second session, and so on.

Recall from above that user preferences can also be used for summary generation. For instance, a user could provide input requesting that narration of a summary be performed in the voice of a particular video game character. Then, when that user is provided a summary, a generative audio model could be employed to use the voice characteristics of the selected character to narrate the summary.

As a further point, some implementations may employ moving video for summaries instead of static video frames. For instance, video clips can be selectively stored as platform log data in a manner similar to that described above for individual video frames, and those clips can be replayed during summary presentation, potentially with modification by a generative image model. In other implementations, static video frames are stored during game execution and a generative image model is employed to interpolate between the static frames to generate a video clip that is presented as a summary. In still further implementations, an entire video feed from a gaming session can be fed to a generative model that can select clips from the video feed and then generate narratives describing the selected clips.

As a further point, note that the disclosed concepts are also applicable to virtual and/or augmented reality video games, as well as three-dimensional video. For instance, a video game player that navigates a virtual world using a virtual or augmented reality headset could be presented a summary of their experiences in the virtual world the next time they use the headset. In such implementations, eye gaze and/or gestures could be used to detect real or virtual objects that the user engages with during a given session. The identities of these objects could be provided to a generative model for summary generation. Thus, for instance, if a user navigates a virtual room with furniture and various appliances and the user gazes and/or gestures at the appliances but not the furniture, the summary of that session could focus on the appliances instead of the furniture.

Furthermore, note that the disclosed concepts can also be implemented for other types of computer applications besides video games. For instance, consider a flight simulator where a user is learning how to fly an airplane. If the user flies through a simulated storm with low visibility and uses their instruments for navigation during a given session, the user can be presented with a summary of their instrument readings and how they controlled the airplane based on the instrument readings.

### Technical Effect

As noted previously, one way to summarize a previous video gaming session involves using a snapshot from that session to remind a video game player of where they left off in a game. For relatively simple games or for scenarios where players have played recently, this can be an adequate way to re-immerse players back into the video game experience. However, for more complex game scenarios where players have taken a longer time away from playing a given video game, this approach can be unsatisfactory.

The disclosed implementations can employ generative machine learning models to generate more comprehensive, informative summaries of previous video gaming sessions. By generating narratives and/or images that convey salient events from a previous video gaming session, a video game player can be re-immersed into the video gaming experience in a comprehensive manner.

One approach for generating summaries as described herein could involve comprehensive logging of platform log entries. However, this can be burdensome because of processing, storage, and/or network resources employed, e.g., to store every video, audio, and/or haptic frame output by the video game and/or every user input provided to the video game. As noted above, some implementations utilize application programming interface calls from the game executable, analysis of content of the video game log data (e.g., using computer vision techniques), and/or user input activity to selectively log platform data. This allows for capturing platform log entries that are sufficient for generating comprehensive summaries of a video gaming session in a resource-efficient manner, while omitting generation of log entries that are redundant and/or otherwise not particularly useful for summary generation.

One way to generate summaries could involve inputting all game executable log entries and/or all platform executable log entries into a generative machine learning model for summary generation. However, this approach could also tend to burden processing, storage, and/or network resources. As also noted above, some implementations may filter which game executable log entries and/or platform log entries are input to a generative model for summarization. This again can allow for effective generation of summaries while conserving resources.

As a final point, some implementations may perform summary generation offline. This can allow for efficient use of computational resources, because some of the context employed by a generative machine learning model for generating a given narrative can be provided in an initial prompt. Thereafter, the generative machine learning model be prompted multiple additional times to generate multiple narratives based on the context provided in the initial prompt. This saves memory, processor, and/or network resources that would otherwise be employed to provide that context with each of the subsequent prompts. Moreover, this approach to offline summary generation allows for summaries to be available for presentation the next time that a video game player requests to initiate a new gaming session. Thus, the summaries can be presented in a low-latency manner, e.g., while the video game loads the next session.

### Example Decoder-Based Generative Language Model

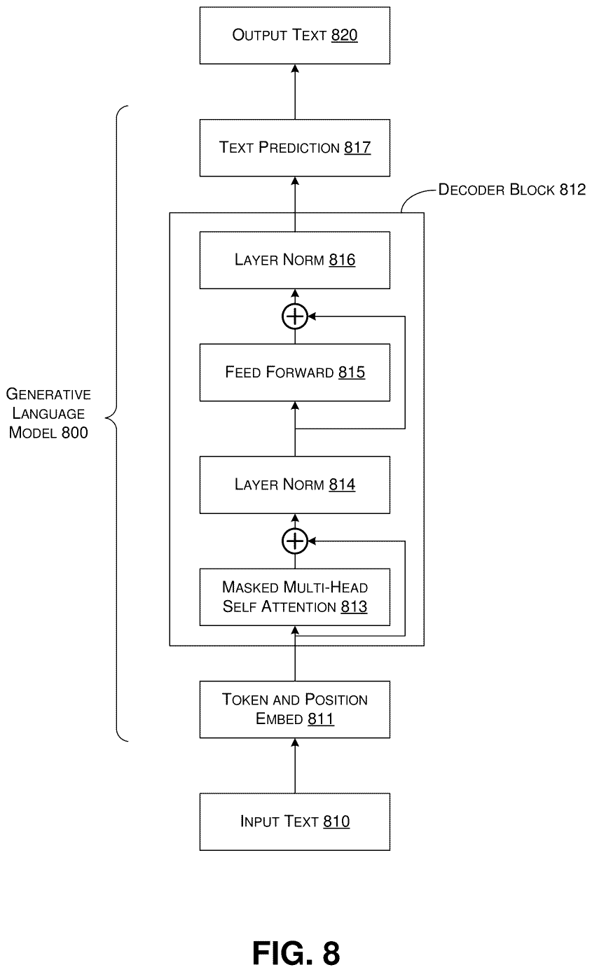

FIG. 8 illustrates an exemplary generative language model 800 (e.g., a transformer-based decoder) that can be employed using the disclosed implementations. (Radford, et al., “Improving language understanding by generative pre-training,” 2018). Generative language model 800 is an example of a machine learning model that can be used to perform one or more natural language processing tasks that involve generating text, as discussed more below. For the purposes of this document, the term “natural language” means language that is normally used by human beings for writing or conversation.

Generative language model 800 can receive input text 810, e.g., a prompt from a user or a prompt generated automatically by machine learning using the disclosed techniques. For instance, the input text can include words, sentences, phrases, or other representations of language. The input text can be broken into tokens and mapped to token and position embeddings 811 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 811 are processed in one or more decoder blocks 812. Each decoder block implements masked multi-head self-attention 813, which is a mechanism relating different positions of tokens within the input text to compute the similarities between those tokens. Each token embedding is represented as a weighted sum of other tokens in the input text. Attention is only applied for already-decoded values, and future values are masked. Layer normalization 814 normalizes features to mean values of 0 and variance to 1, resulting in smooth gradients. Feed forward layer 815 transforms these features into a representation suitable for the next iteration of decoding, after which another layer normalization 816 is applied. Multiple instances of decoder blocks can operate sequentially on input text, with each subsequent decoder block operating on the output of a preceding decoder block. After the final decoding block, text prediction layer 817 can predict the next word in the sequence, which is output as output text 820 in response to the input text 810 and also fed back into the language model. The output text can be a newly-generated response to the prompt provided as input text to the generative language model.

Generative language model 800 can be trained using techniques such as next-token prediction or masked language modeling on a large, diverse corpus of documents. For instance, the text prediction layer 817 can predict the next token in a given document, and parameters of the decoder block 812 and/or text prediction layer can be adjusted when the predicted token is incorrect. In some cases, a generative language model can be pretrained on a large corpus of documents. Then, a pretrained generative language model can be tuned using a reinforcement learning technique such as reinforcement learning from human feedback (“RLHF”).

### Example Generative Image Model

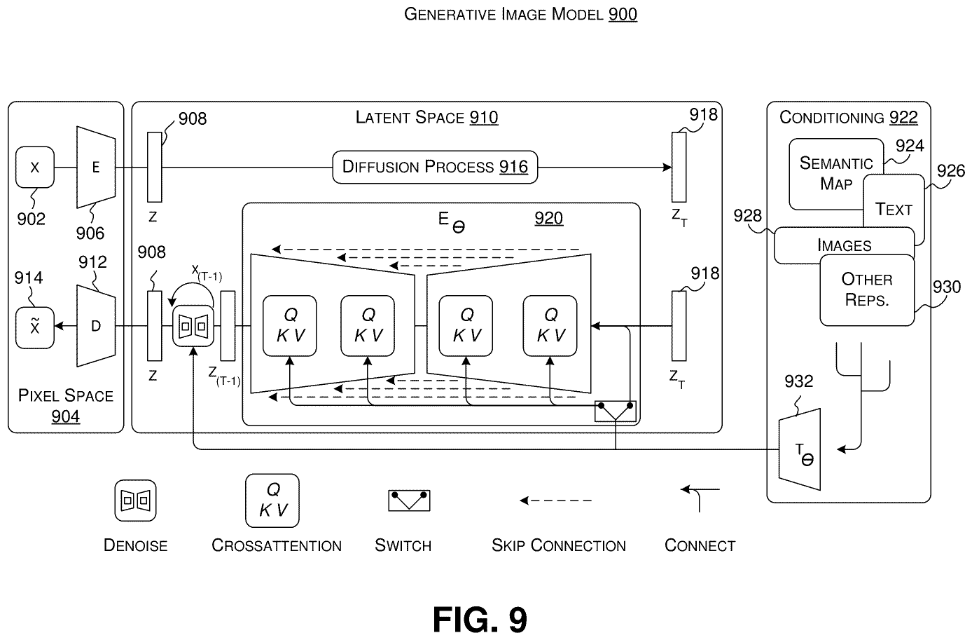

FIG. 9 illustrates an example generative image model 900. For instance, generative image model 900 can be implemented as a Stable Diffusion model (Rombach, et al., “High-Resolution Image Synthesis with Latent Diffusion Models,” Proceedings of the IEEE/CVF Conference on Computer Vision and Pattern Recognition, 2022), in which an image 902 (X) in pixel space 904 (e.g., red, green, blue) is encoded by an encoder 906 (E) into a representation 908 (Z) in a latent space 910. A decoder 912 (D) is trained to decode the latent representation Z to produce a reconstructed image 914 (X~) in the pixel space. For instance, the encoder can be trained (with the decoder) as a variational autoencoder using a reconstruction loss term with a regularization term.

In the latent space 910, a diffusion process 916 adds noise to obtain a noisy representation 918 (Z_{T}). A denoising component 920 (E_{θ}) is trained to predict the noise in the compressed latent image Z_{T}. The denoising component can include a series of denoising autoencoders implemented using UNet 2D convolutional layers.

The denoising can involve conditioning 922 on other modalities, such as a semantic map 924, text 926, images 928, or other representations 930 which can be processed to obtain an encoded representation 932 (T_{θ}). For instance, text can be encoded using a text encoder (e.g., BERT, CLIP, etc.) to obtain the encoded representation. This encoded representation can be mapped to layers of the denoising component using cross-attention. The result is a text-conditioned latent diffusion model that can be employed to generate images conditioned on text inputs. To train a model such as CLIP, pairs of images and captions can be obtained from a dataset to encode both the images and captions, and the encoder can be trained to represent pairs of images and captions with similar embeddings.

Generative image model 900 can be employed for text to image generation, where an image is generated from a text prompt. Text prompts can be provided by users or generated automatically by machine learning using the disclosed techniques. In other cases, generative image model 900 can be employed for image-to-image mode, where an image is generated using an input image as well as a user or machine-generated text prompt. Generative image model 900 can also be employed for inpainting, where parts of an image are masked and remain fixed while the rest of the image is generated by the model, in some cases conditioned on a user or machine-generated text prompt.

In some cases, generative image model 900 can be guided by a separate network, such as a ControlNet (Zhang, et al., “Adding Conditional Control to Text-to-Image Diffusion Models,” Proceedings of the IEEE/CVF International Conference on Computer Vision, 2023). For instance, a ControlNet can guide the generative model to produce an image that preserves certain aspects of another image, e.g., the spatial layout and salient features of an image prior. A ControlNet can be implemented by locking the parameters of generative image model 900, cloning the model into another copy. The copy is connected to the original model with one or more zero convolutional layers which are then optimized with the parameters of the copy. For instance, the ControlNet can be trained to preserve edges, lines, boundaries, human poses, semantic segmentations, etc. from an image. A ControlNet can also be trained to preserve depth relationships of a user-identified image using a depth map obtained from the user-identified image, etc. The outputs of a ControlNet can be added to connections within the denoising layer. Thus, the generative image model can produce images that are conditioned not only on text, but also aspects of another image.

Generative image model 900 can implement a number of different modes. In a text-to-image mode, an image is generated from a given text prompt. In an image-to-image mode, an image is generated from a text prompt and an input image, and the generated image retains features of the input image while introducing new elements or styles consistent with the prompt. In inpainting/outpainting mode, the processing is similar to the image-to-image mode, but an image mask is used to determine which parts of the image are fixed to match the input image. The rest of the image is generated in a way that is consistent with the fixed parts of the image. Note that the term “inpainting,” as used herein, includes filling in parts of a given image whereas “outpainting” refers to extending an image outward.

### Example Computer Vision Model

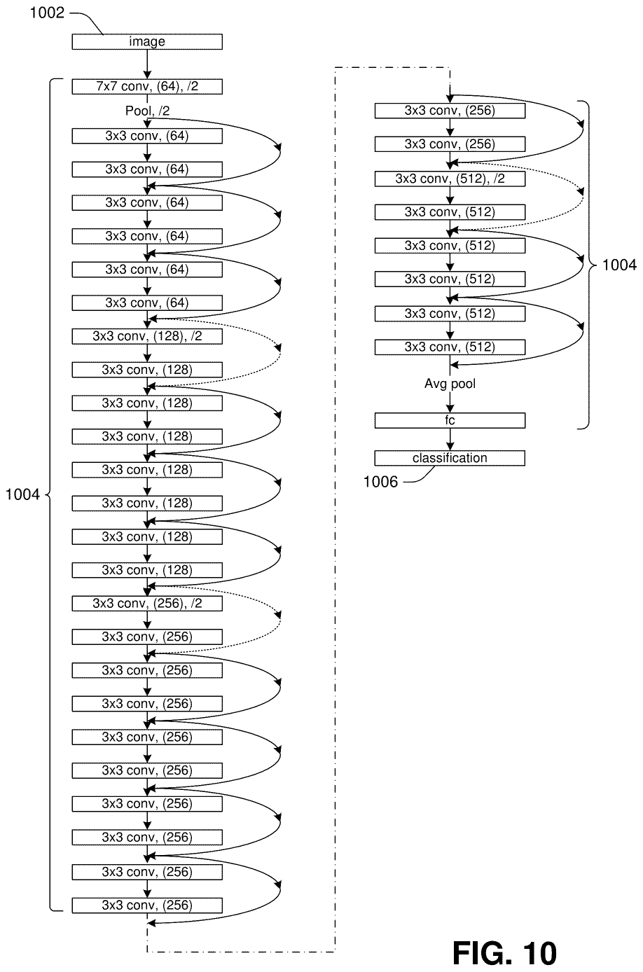

FIG. 10 illustrates a particular example of a neural network model for computer vision. For instance, FIG. 10 shows an image 1002 being classified by a computer vision model 1004 to determine an image classification 1006, where the computer vision model can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters (e.g., 64, 128, 246, 412). If the feature map size is halved by a given convolutional layer (as shown by “/2” in FIG. 10), then the number of filters can be doubled to preserve the time complexity across layers.

After the image has been processed using a series of convolutional layers, the image is processed in a global average pooling layer. The output of the pooling layer is processed with a fully-connected layer with softmax. The fully-connected layer (e.g., one thousand-way) can be used to determine a classification, e.g., an object category of an object in image 1002.

The respective layers within computer vision model 1004 can have shortcut connections which perform identity operations:

y=F(x, {Wᵢ})+x (1)

where x and y are the input and output vectors of the layers involved and F(x, {Wᵢ}) represents the residual mapping learned by the model. In some connections the dimensions increase across layers (shown as dotted lines in FIG. 10). In these cases, the following projection can be employed to match the dimensions via 1×1 convolutions:

y=F(x, {Wᵢ})+Wₛx (2)

In some implementations, computer vision model 1004 can be pretrained on a large dataset of images, such as ImageNet. Such a general-purpose image database can provide a vast number of training examples that allow the model to learn weights that allow generalization across a range of object categories. Said another way, computer vision model 1004 can be pretrained in this fashion.

After pretraining, computer vision model 1004 can be tuned on another, smaller dataset for categories of interest. For instance, tuning datasets can be provided for specific groups of users. As one example, software developers might tend to use UML (Unified Modeling Language) diagrams or directed acyclic graphs, whereas other users might tend to use conventional flow charts, and thus different computer vision models can be tuned for these different sets of users. As another example, social media users might tend to post images of things in their home, such as pets or furniture, whereas business users might tend to post images of graphs, scatterplots, pie charts, etc.

### Example Vision Language Model

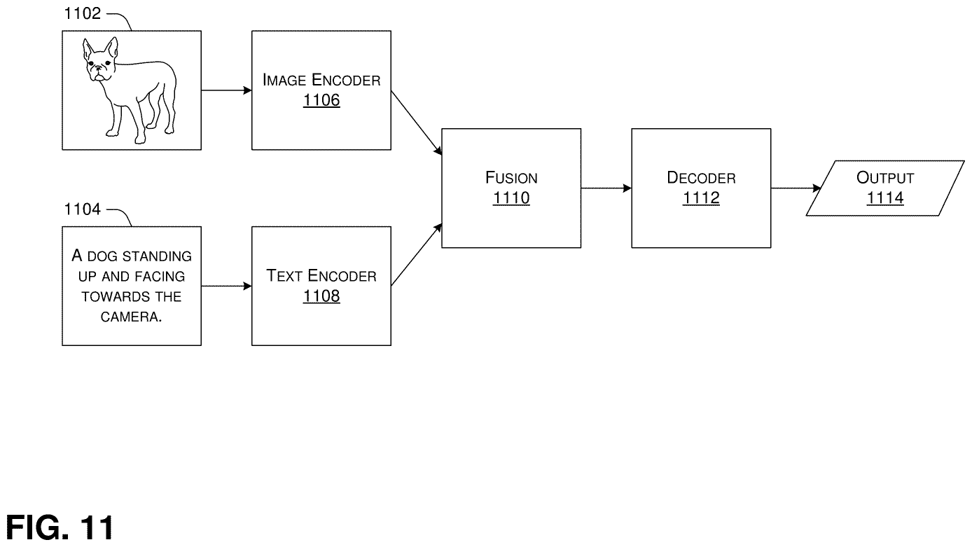

FIG. 11 shows an example vision language model 1100 that can process an input image 1102 and/or a text input 1104. The input image is processed using an image encoder 1106 (e.g., based on computer vision model 1004) and the text input is processed using a text encoder 1108. The image encoder and text encoder produce encodings (e.g., vector embeddings) representing the input image and text input, respectively. A fusion process 1110 can fuse the encodings using techniques such as attention, dot product, etc. A decoder 1112 can decode the fused encodings to produce an output 1114. In some implementations, vision language model 1100 can be a CLIP model (Radford, et al., “Learning transferable visual models from natural language supervision,” International conference on machine learning, July 2021, pp. 8748-8763, PmLR).

In some implementations, the image encoder can also be based on a transformer architecture such as a Vision Transformer (Dosovitskiy, et al., “An Image is Worth 16×16 Words: Transformers for Image Recognition at Scale,” Jun. 3, 2021, arXiv preprint arXiv:2010.11929v2). The text encoder 1108 can be based on a transformer architecture such as BERT or GPT. In other cases, an “early fusion” approach can employ a shared encoder that processes sequences of text and image tokens using a single encoder that determines embeddings for each text or image token. (Chameleon. Team C, “Chameleon: Mixed-Modal Early-Fusion Foundation Models,” 2024, arXiv preprint, arXiv:2404.09818).

The vision language model 1100 can be trained using approaches such as contrastive learning, where the training data includes pairs of text and images and the model is trained to determine whether a given text sample matches a corresponding image sample. In this manner, the image encoder 1106 and the text encoder 1108 can be trained to generate similar embeddings for text and images that represent similar concepts (e.g., the word “bear” and an image of a bear). Other approaches include masked image modeling and/or masked language modeling and image-text modeling.

The output 1114 can characterize an image. For instance, the output can answer a visual question, caption the image, etc. The output can also identify detected objects, classify detected objects, perform image segmentation, etc. In some cases, the vision language model 1100 can determine a label for an object in an input image. The labels can identify a category of the object (e.g., “bed” or “sofa”), a description of the object (e.g., “a queen-sized bed with blue bedding and a headboard”), or even specify information such as a brand of the object (e.g., “ABC brand queen size platform bed”), etc. The output can also specify relationships between detected objects, e.g., “the bear is riding the unicycle in the circus ring,” etc.

### Device Implementations

As noted above with respect to FIG. 6, system 600 includes several devices, including a client device 610, a client device 620, and game server 630. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the techniques described herein. For example, the methods and functionality described herein can be performed on a single computing device and/or distributed across multiple computing devices that communicate over network(s) 640. Without limitation, network(s) 640 can include one or more local area networks (LANs), wide area networks (WANs), the Internet, and the like.

Various examples are described above. Additional examples are described below. One example includes a computer-implemented method comprising accessing a database storing video game log data relating to a previous video gaming session involving a video game player playing a video game, selecting a subset of video game log data from the database for summarization by a generative machine learning model, inputting the selected subset of video game log data to the generative machine learning model, instructing the generative machine learning model to synthesize a summary of the previous video gaming session based at least on the selected subset of video game log data, receiving the synthesized summary of the previous video gaming session from the generative machine learning model, and outputting the synthesized summary of the previous video gaming session to the video game player.

Another example includes a computer-implemented method comprising accessing a database storing video game log data relating to a previous video gaming session involving a video game player playing a video game, selecting a subset of video game log data from the database for summarization by a generative machine learning model, inputting the selected subset of video game log data to the generative machine learning model, instructing the generative machine learning model to synthesize a summary of the previous video gaming session based at least on the selected subset of video game log data, receiving the synthesized summary of the previous video gaming session from the generative machine learning model, and outputting the synthesized summary of the previous video gaming session to the video game player. The video game data in the database can be selectively stored by a video gaming platform based on at least one of user input activity, content of the video game log data, or application programming interface calls by the video game.

Another example can include any of the above and/or below examples where the method further comprises outputting the synthesized summary of the previous video gaming session responsive to initiation of a subsequent video gaming session by the video game player.

Another example can include any of the above and/or below examples where the method further comprises outputting the synthesized summary of the previous video gaming session as the video game is loading for execution of the subsequent video gaming session.

Another example can include any of the above and/or below examples where the method further comprises the video game log data includes game executable log data identifying in-game events that occurred during the previous video gaming session.

Another example can include any of the above and/or below examples where the method further comprises the video game log data includes platform log data logged by a video gaming platform during the previous video gaming session.

Another example can include any of the above and/or below examples where the method further comprises the subset of video game data includes selected video frames from the platform log data.

Another example can include any of the above and/or below examples where the method further comprises choosing the selected video frames from the platform log data based at least on the game executable log data, an application programming interface call by the video game during the previous video gaming session, or analysis of the selected video frames by the generative machine learning model.

Another example can include any of the above and/or below examples where the method further comprises the synthesized summary includes a synthesized narrative describing the selected video game frames.

Another example can include any of the above and/or below examples where the method further comprises the synthesized narrative is output as the selected video frames are displayed to the video game player.

Another example can include any of the above and/or below examples where the method further comprises the synthesized narrative is presented via audio narration.

Another example can include any of the above and/or below examples where the method further comprises the audio narration is performed in a voice of a selected character in the video game.

Another example can include any of the above and/or below examples where the method further comprises the selected character is designated by the video game player.

Another example can include any of the above and/or below examples where the method further comprises modifying an individual selected video frame with a generative image model prior to outputting the individual selected video frame.

Another example can include any of the above and/or below examples where the method further comprises selectively storing video frames in the video game log data based on at least one of user input activity, content of the video frames, or application programming interface calls by the video game.

Another example can include any of the above and/or below examples where the method further comprises accessing a knowledge graph describing entities that appear in the video game, traversing the knowledge graph to extract information relating to a subset of entities that appeared in the previous video gaming session, and inputting the extracted information to the generative machine learning model with an instruction to generate the synthesized summary.

Another example can include a system comprising a processor, and a storage medium storing instructions which, when executed by the processor, cause the system to access a database storing video game log data relating to a previous video gaming session involving a particular video game player playing a particular video game, select a subset of video game log data from the database for summarization by a generative machine learning model, input the selected subset of video game log data to the generative machine learning model, instruct the generative machine learning model to synthesize a summary of the previous video gaming session based at least on the selected subset of video game log data, receive the synthesized summary of the previous video gaming session from the generative machine learning model, and output the synthesized summary of the previous video gaming session to the particular video game player.

Another example can include a system comprising a processor, and a storage medium storing instructions which, when executed by the processor, cause the system to access a database storing video game log data relating to a previous video gaming session involving a particular video game player playing a particular video game, select a subset of video game log data from the database for summarization by a generative machine learning model, input the selected subset of video game log data to the generative machine learning model, instruct the generative machine learning model to synthesize a summary of the previous video gaming session based at least on the selected subset of video game log data, receive the synthesized summary of the previous video gaming session from the generative machine learning model, and output the synthesized summary of the previous video gaming session to the particular video game player. The video game data in the database can be selectively stored by a video gaming platform based on at least one of user input activity, content of the video game log data, or application programming interface calls by the video game.

Another example can include any of the above and/or below examples where the system further comprises the synthesized summary describes multiple previous video gaming sessions.

Another example can include any of the above and/or below examples where the system further comprises the instructions, when executed by the processor, cause the system to receive a user query relating to the previous video gaming session, prompt the generative machine learning model to synthesize an answer to the user query based at least on the video game log data in the database, and output the synthesized answer in response to the user query.

Another example can include any of the above and/or below examples where the system further comprises the subset of video game log data includes at least one of game executable log data or platform log data.

Another example can include a computer-readable storage medium storing instructions which, when executed by a processing device, cause the processing device to perform acts comprising accessing a database storing video game log data relating to a previous video gaming session involving a video game player playing a video game, selecting a subset of video game log data from the database for summarization by a generative machine learning model, inputting the selected subset of video game log data to the generative machine learning model, instructing the generative machine learning model to synthesize a summary of the previous video gaming session based at least on the selected subset of video game log data, receiving the synthesized summary of the previous video gaming session from the generative machine learning model, and outputting the synthesized summary of the previous video gaming session to the video game player.

Another example can include a computer-readable storage medium storing instructions which, when executed by a processing device, cause the processing device to perform acts comprising accessing a database storing video game log data relating to a previous video gaming session involving a video game player playing a video game, selecting a subset of video game log data from the database for summarization by a generative machine learning model, inputting the selected subset of video game log data to the generative machine learning model, instructing the generative machine learning model to synthesize a summary of the previous video gaming session based at least on the selected subset of video game log data, receiving the synthesized summary of the previous video gaming session from the generative machine learning model, and outputting the synthesized summary of the previous video gaming session to the video game player. The video game data in the database can be selectively stored by a video gaming platform based on at least one of user input activity, content of the video game log data, or application programming interface calls by the video game.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method, comprising:
accessing a database storing video game log data relating to a previous video gaming session involving a video game player playing a video game;
selecting a subset of video game log data from the database for summarization by a generative machine learning model;
inputting the selected subset of video game log data to the generative machine learning model;
instructing the generative machine learning model to synthesize a summary of the previous video gaming session based at least on the selected subset of video game log data;
receiving the synthesized summary of the previous video gaming session from the generative machine learning model; and
outputting the synthesized summary of the previous video gaming session to the video game player.

2. The computer-implemented method of claim 1, further comprising:
outputting the synthesized summary of the previous video gaming session responsive to initiation of a subsequent video gaming session by the video game player.

3. The computer-implemented method of claim 2, further comprising:
outputting the synthesized summary of the previous video gaming session as the video game is loading for execution of the subsequent video gaming session.

4. The computer-implemented method of claim 1, wherein the video game log data includes game executable log data identifying in-game events that occurred during the previous video gaming session.

5. The computer-implemented method of claim 4, wherein the video game log data includes platform log data logged by a video gaming platform during the previous video gaming session.

6. The computer-implemented method of claim 5, wherein the subset of video game data includes selected video frames from the platform log data.

7. The computer-implemented method of claim 6, further comprising:
choosing the selected video frames from the platform log data based at least on the game executable log data, an application programming interface call by the video game during the previous video gaming session, or analysis of the selected video frames by the generative machine learning model.

8. The computer-implemented method of claim 6, wherein the synthesized summary includes a synthesized narrative describing the selected video game frames.

9. The computer-implemented method of claim 8, wherein the synthesized narrative is output as the selected video frames are displayed to the video game player.

10. The computer-implemented method of claim 9, wherein the synthesized narrative is presented via audio narration.

11. The computer-implemented method of claim 10, wherein the audio narration is performed in a voice of a selected character in the video game.

12. The computer-implemented method of claim 11, wherein the selected character is designated by the video game player.

13. The computer-implemented method of claim 9, further comprising:
modifying an individual selected video frame with a generative image model prior to outputting the individual selected video frame.

14. The computer-implemented method of claim 1, further comprising:
selectively storing video frames in the video game log data based on at least one of user input activity, content of the video frames, or application programming interface calls by the video game.

15. The computer-implemented method of claim 1, further comprising:
accessing a knowledge graph describing entities that appear in the video game;
traversing the knowledge graph to extract information relating to a subset of entities that appeared in the previous video gaming session; and
inputting the extracted information to the generative machine learning model with an instruction to generate the synthesized summary.

16. A system comprising:
a processor; and
a storage medium storing instructions which, when executed by the processor, cause the system to:
access a database storing video game log data relating to a previous video gaming session involving a particular video game player playing a particular video game;
select a subset of video game log data from the database for summarization by a generative machine learning model;
input the selected subset of video game log data to the generative machine learning model;
instruct the generative machine learning model to synthesize a summary of the previous video gaming session based at least on the selected subset of video game log data;
receive the synthesized summary of the previous video gaming session from the generative machine learning model; and
output the synthesized summary of the previous video gaming session to the particular video game player.

17. The system of claim 16, wherein the synthesized summary describes multiple previous video gaming sessions.

18. The system of claim 16, wherein the instructions, when executed by the processor, cause the system to:
receive a user query relating to the previous video gaming session;
prompt the generative machine learning model to synthesize an answer to the user query based at least on the video game log data in the database; and
output the synthesized answer in response to the user query.

19. The system of claim 16, wherein the subset of video game log data includes at least one of game executable log data or platform log data.

20. A computer-readable storage medium storing instructions which, when executed by a processing device, cause the processing device to perform acts comprising:
accessing a database storing video game log data relating to a previous video gaming session involving a video game player playing a video game;
selecting a subset of video game log data from the database for summarization by a generative machine learning model;
inputting the selected subset of video game log data to the generative machine learning model;
instructing the generative machine learning model to synthesize a summary of the previous video gaming session based at least on the selected subset of video game log data;
receiving the synthesized summary of the previous video gaming session from the generative machine learning model; and
outputting the synthesized summary of the previous video gaming session to the video game player.
